(19) United States
(12) Patent Application Publication
(10) Pub. No.: US 2018/0075683 A1
(43) Pub. Date: Mar. 15, 2018

(54) METHOD FOR GENERATING PREDICTABLE WINNING NUMBER RANGE

(71) Applicant: Kang INJUN, Daejeon (KR)

(72) Inventor: Kang INJUN, Daejeon (KR)

(21) Appl. No.: 15/556,299

(22) PCT Filed: Feb. 3, 2016
(86) PCT No.: PCT/KR2016/002089

§ 371 Date: Sep. 7, 2017

(30) Foreign Application Priority Data
Mar. 17, 2015 (KR) 10-2015-0036867

(51) Int. Cl. G07C 15/00; G07F 17/32; G06Q 50/34

(52) U.S. Cl. CPC G07C 15/006; G06Q 50/34; G07F 17/329

(57) ABSTRACT

The present invention relates to a method for generating a predictable winning number range and, more preferably, to a predictable winning number range generation for analyzing and extracting, by sections and in stages, a number range formed from a portion of every time-predictable winning numbers in a group of number ranges in which winning numbers are delimited to six out of forty-five numbers, generating image format data, having a rule, from the number range so as to provide the data to a user, and enabling the user to extract and directly determine six predictable winning numbers including odd numbers and even numbers according to the rule determined in the image format data.

### TECHNICAL FIELD

The present invention relates to a method of generating predicted winning number ranges, and more particularly to a predicted winning number range generating method of extracting number ranges including some numbers which are predicted to be winning numbers for each round in a group of number ranges in which six winning numbers are defined from 45 numbers through analysis by sections and by phases, generating the number ranges as image-type data having a rule, providing a winning number prediction application to a smartphone via the Internet, and allowing a user to access the winning number prediction application and to directly extract and determine six predicted winning numbers including odd numbers and even numbers in the rule of the image-type data.

### BACKGROUND ART

In general, at 6/45 lotto, a probability that six numbers among 1 to 45 will coincide with six winning numbers is 1/8,145,060.

Depending on such a probability, users combine often coming-up numbers as the winning numbers in the past, convert details of lucky dreams or fortunes into numerals or the like, arbitrarily mark a lotto ticket sheet, or select automatic and semiautomatic issuing manners in selling houses in which a lotto terminal is installed.

In order to enhance a winning probability at lotto, users are provided with six numbers from many lottery service providers over the Internet using with a fee or without a fee Whitson method of storing lotto winning numbers may come up recently and using sample count testing power, a Gaussian method of finding a high probability distribution, a Huygens method using an expected value, or the like or extracting six numbers from 45 numbers through various mathematical and statistical methods, analysis methods, and filtering.

However, since data for visually comparing change tendencies of the lotto winning numbers from the past to the present is not provided, conventional users and lottery service providers have difficulty in determining what is different from the lotto winning numbers.

The mathematical principle that the winning probability of six continuous lotto winning numbers (for example, 1, 2, 3, 4, 5, 6) is 1/5,864,443,000(=1/45×44×43×42×41×40) which is very low is known, but such numbers cannot be visually compared, basically excluded, or selected using a verification mechanism. Accordingly, there is a problem in that continuous six numbers which may be winning numbers are unconditionally excluded on the basis of only the mathematical principle that the winning probability thereof is low.

In a technical configuration disclosed in Korean Patent No 10-1140294, since six numbers including odd numbers and even numbers in predicted winning number ranges in an arrangement type (even rows×seven columns) of a lotto ticket sheet are constituted by often coming-up numbers and not often coming-up numbers and selected numbers are randomly extracted to correspond to an expected value of the probability, there is a problem in that the frequency of repeated extraction is high. In addition, there is a problem in that repeated combinations including discarded numbers occur due to random extraction of new number ranges without any defined section at lotto 6/45 for each round.

There is a problem in that odd numbers and even numbers have to be infinitely extracted by the number of cases in a combination principle as two classifications of often coming-up numbers and not often coming-up numbers and a user provided with six predicted lotto winning numbers from a lottery service provider has difficulty in determining what number should be corrected or excluded among numbers including odd numbers and even numbers, due to is no verification function of numbers, even when the user arbitrarily correct or exclude numbers.

Although a user arbitrarily extracts predicted winning number ranges or corrects or excludes numbers using a combination machine provided from a lottery service provider, there is a problem in that the user does not know the reason for correction or exclusion and thus manually select numbers in accordance with an instruction from the combination machine.

Korean Unexamined Patent Application Publication No. 10-2009-0066998 discloses a technique of extracting predicted numbers by simple calculation using a conversion rule or a conversion calculation rule as if one or more persons play dice with a lotto dice board including a conversion table or an operation table, a lotto number table, and a round record using numbers from a disdyakis dodecahedral dice, but is a simple game with low accuracy.

Korean Unexamined Patent Application Publication No. 10-2014-0050925 discloses a configuration including a winning number DB that stores winning numbers for each round in the past; and a server that extracts predicted winning numbers using extraction filters based on statistical analysis results for a sum of the winning numbers for each round which is calculated using the winning numbers stored in the winning number DB, a high-low ratio of a high value and a low value which is calculated with respect to a median value of selectable numbers of the winding numbers for each round using the stored winning numbers, an odd-even ratio of odd numbers and even numbers of the winning numbers for each round which is calculated using the stored winning numbers, a high-low sum which is calculated by summing the highest number and the lowest number of the winning numbers for each round using the stored winning numbers, a first-number sum which is calculated by summing the front-digit numbers of the winning numbers for each round using the stored winning numbers, and a final-number sum which is calculated by summing the first-digit numbers of the winning numbers for each round using the stored winning numbers. In this configuration, since the predicted winning numbers are combined using a computer, a user cannot obtain a real feeling for visually predicting winning numbers.

### CITATION LIST5

### Patent Literature

Patent Literature 1: Korean Patent No. 10-1140294

Patent Literature 2: Korean Unexamined Patent Application Publication No. 10-2009-0066998

Patent Literature 3: Korean Unexamined Patent Application Publication No. 10-2014-0050925

### SUMMARY OF INVENTION

### Technical Problem

The invention is made to solve the above-mentioned problems and an object thereof is to enhance a winning probability and to supply X-type data or Y-type data in an image format with a rule including number ranges of predicted winning numbers, because, in consideration of reality that users a changeable tendency of winning numbers is analyzed and predicted winning numbers are extracted through classification into often coming-up numbers and otherwise numbers, number ranges of 45 numbers are classified by three sections (by numbers) and nine phases (by previous tendencies) among 262,144 types of number ranges, are finely analyzed, and are visually represented to prevent discarding and repeated combinations of individual numbers for extraction of number ranges for each round, and a user can confirm what section of the numbers progresses in what direction with respect to the winning numbers using a winning number prediction application installed in a smartphone via the Internet.

Therefore, correction or deletion of predicted winning numbers can be logically performed and even a number having a very low winning probability can be selected or excluded.

In the past, a user or a lottery service provider newly selected a number range predicted to have a high lotto winning probability and repeatedly extracted six numbers, but another object of the invention is to enhance a winning probability by providing a mechanism that can extract and verify a predicted winning range by comparing and analyzing a tendency of winning number ranges including lotto winning numbers for each round in only a group in which winning number ranges are defined.

Number ranges are extracted by predicting a tendency of winning numbers in three sections and nine phases in a group in which the winning number ranges are defined in 262,144 types, the winning number ranges are generated in an X type and a Y type in which nine columns X five rows instead of the arrangement of a lotto ticket sheet (seven columns x seven rows), and image type data with a verification mechanism of an X type and a Y type is provided via a winning number prediction application installed in a smartphone via the Internet. Accordingly, a user is allowed to directly determine a number to be excluded or a number to be selected in accordance with a rule.

### Solution to Problem

A configuration of the invention for achieving the above-mentioned objects will be described below with reference to the accompanying drawings.

A method of generating a predicted winning number range according to the invention includes:

a downloading step of downloading a winning number prediction application that provides a predicted winning number range to a smartphone via the Internet, the predicted winning number range including a combination of X-axis number arrays (X) in which numbers 1 to 45 are sequentially or randomly described horizontally along horizontal arrays of nine numbers and vertical arrays of five numbers and a combination of Y-axis number arrays (Y) in which numbers 1 to 45 are sequentially or randomly described vertically along horizontal arrays of nine numbers and vertical arrays of five numbers;

a step of accessing the winning number prediction application, registering as a member, and logging on to the winning number prediction application;

a step of transmitting a request for predicted winning number range data in which the predicted winning number range is combined from the winning number prediction application to a management server;

a step of transmitting the requested predicted winning number range data from the management server to the winning number prediction application;

a step of sequentially or randomly inputting X-axis and Y-axis section number array sets X(A, B, C) and Y(A, B, C) and a group of individual number array sets (x, y) to the predicted winning number range data, the X-axis and Y-axis section number array sets X(A, B, C) and Y(A, B, C) including section number array sets by dividing the combination of X-axis number arrays (X) and the combination of Y-axis number arrays (Y) for predicted winning numbers three sections (A, B, C) based on the transmitted predicted winning number range data such that three horizontal number array sections (123), (245), and (789) and five vertical number arrays (12345) are formed and the group of individual number array sets (x, y) including eight types of groups (abcd) and (efgh) in which the X-axis section number array set includes three horizontal (x) number arrays (123) and five vertical (y) number arrays (12345);

a step of extracting a common number (x∩y) of groups of x and y double set arrays (2, 3) which is formed such that four types (2: aecg) and (3: bfdh) of groups are defined to form a predicted number set in the group of the individual number array sets (x, y), extracting the predicted winning number range of individual sets (A+B+C), displaying the predicted winning number range in an image type on a display, and allowing a user to select predicted winning numbers from the displayed predicted winning number range and to request the management server to analyze the predicted winning numbers; and

a step of analyzing the predicted winning numbers input by the user and transmitting final predicted winning numbers to the winning number prediction application.

### Advantageous Effects of the Invention

According to the invention, predicted number ranges are extracted in the X type and the Y type by defining a predicted winning number range into 64 sections and analyzing a tendency of winning numbers in the sections for each round, and then a reduced number range can be provided by applying a fixed rule thereto.

According to the invention, it is possible to obtain a real feeling for visually predicting winning numbers by extracting previous winning numbers, displaying groups thereof in nine phases, and displaying a tendency of predicted winning numbers in a graph from the past to the future.

### BRIEF DESCRIPTION OF THE DRAWINGS

FIG. 1 is a diagram illustrating a configuration for generating a predicted winning number range according to the invention.

FIG. 2 is a configuration diagram illustrating a predicted winning number range according to the invention.

FIG. 3 is a graph visually illustrating predicted winning numbers according to the invention.

FIG. 4 is a graph visually illustrating sums in the phases illustrated in FIG. 3 according to the invention.

FIG. 5 is a flowchart illustrating the method of generating a predicted winning number range according to the invention.

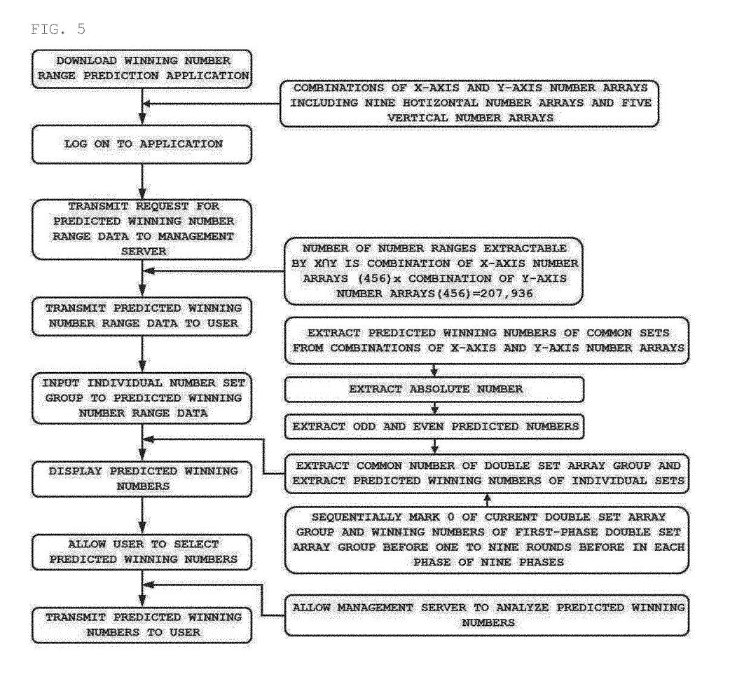

### EMBODIMENTS OF THE INVENTION

Hereinafter, embodiments of the invention will be described in detail with reference to the accompanying drawings.

A configuration for generating a predicted winning number range according to the invention includes a combination of X-axis number arrays (X) in which numbers 1 to 45 are sequentially or randomly described horizontally along horizontal arrays of nine numbers and vertical arrays of five numbers and a combination of Y-axis number arrays (Y) in which numbers 1 to 45 are sequentially or randomly described vertically along horizontal arrays of nine numbers and vertical arrays of five numbers. The combination of X-axis number arrays and the combination of Y-axis number arrays can be downloaded to a smartphone via the Internet.

The combination of X-axis number arrays and the combination of Y-axis number arrays may be acquired by allowing a user to arbitrarily describe numbers without repetition. These array combinations are referred to as random array combinations.

In the following embodiment, the combination of X-axis number arrays (X) and the combination of Y-axis number arrays (Y) which include sequential number arrays will be first described for the purpose of easy understanding and then execution of a winning number prediction application having the above-mentioned configuration will be described in detail.

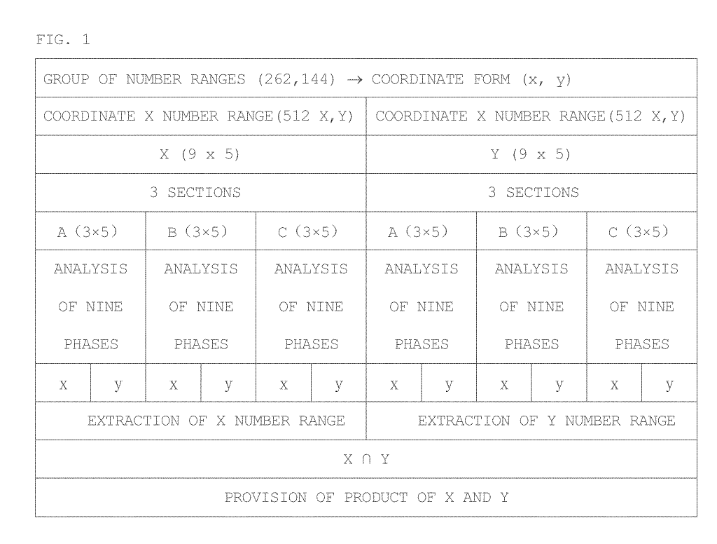

Array combinations of predicted winning numbers which are obtained by the above-mentioned configuration will be specifically described with reference to FIG. 1.

1. Horizontal arrays and vertical arrays of X and Y in a 9×5 form

1) Conditions: Table 1 shows an example in which X-type horizontal number arrays are converted into Y-type vertical number arrays.

2) The 617-th lotto of which winning numbers are 4, 5, 11, 12, 24, and 27 (three odd numbers and three even numbers) and a bonus number is excluded will be exemplified.

Vertical lines including the winning numbers are all marked with black in the X type and the Y type as shown in Table 2.

The combination of X-axis number arrays and the combination of Y-axis number arrays include the same winning numbers and are different only in positions of vertical lines in which the winning numbers are described and which are marked with black.

Numbers at the positions of the vertical lines marked with black are candidates for predicted numbers in the combination of X-axis number arrays and the combination of Y-axis number arrays. In the invention, the positions marked with black in the combination of X-axis number arrays and the combination of Y-axis number arrays are extracted.

3) The number of candidates for predicted winning numbers in the combination of X-axis number arrays is 30 and the number of candidates for predicted winning numbers is 20.

4) When six predicted winning numbers are extracted from only the combination of X-axis number arrays, the number of cases is ₃₀C₆=593,775. As for the combination of Y-axis number arrays, the number of cases is ₂₀C₆=38,760.

5) As shown in Table 3, the number of common numbers in xny is 16, which means that the numbers of candidates in X and Y decrease. The probability thereof increases to 1/₁₆C₆= 1/8,008.

6) In the combination of X-axis number arrays and the combination of Y-axis number arrays, the number of odd numbers is nine, the number of even numbers is 7, and the total is 16.

Selection of odd numbers and even numbers: Since the candidates for predicted winning numbers are extracted on the basis of a tendency of the winning numbers, odd numbers and even numbers can be extracted from only the candidates on the assumption that winning numbers come up from only the candidates.

For example, in case of the winning numbers of the 617-th lotto, the number of odd numbers in the 16 common numbers are large two than the number of even numbers. Accordingly, it can be intuitively determined that there is a high likelihood that winning numbers will include more odd numbers than even numbers. Since the odd numbers is more by 22.3% than the even numbers, six winning numbers can be configured in (three odd numbers, three even numbers) or (four odd numbers, two even numbers), which can enhance the winning probability.

7) Application of a fixed rule: Since on the vertical lines including winning numbers in the combination of X-axis number arrays and the combination of Y-axis number arrays are marked and numbers of xnY are extracted, Rule 1 that the same six numbers should be selected in the combination of X-axis number arrays and the combination of Y-axis number arrays in spite of different positions and Rule 2 that numbers capable of filling the vertical lines in the combination of X-axis number arrays and the combination of Y-axis number arrays should be selected are applied to the combination of X-axis number arrays and the combination of Y-axis number arrays.

That is, six numbers filling six vertical lines in the combination of X-axis number arrays can be selected as numbers filling four vertical lines in the combination of Y-axis number arrays.

Conclusion: Since successful prediction of winning numbers depends on how the number of cases can be reduced, the probability differs much depending on what method is used.

Since the number of common numbers of xnY is less than the number of numbers of the combination of X-axis number arrays or the combination of Y-axis number arrays having the less vertical lines of the combination of X-axis number arrays and the combination of Y-axis number arrays, the winning probability is enhanced as much.

When predicted winning numbers are selected from the common numbers of the combination of X-axis number arrays and the combination of Y-axis number arrays using the rules having an automatic verification function, the wining probability is further enhanced.

8) Probability enhanced by applying an automatic verification function (rule)

8-1) As shown in Table 4,

### EXAMPLE 1

It is assumed that the winning numbers are 1, 2, 3, 4, 5, and 6 (three odd numbers and three even numbers).

X and Y indicate the combination of X-axis number arrays and the combination of Y-axis number arrays, respectively.

In the rule of the invention, when number 1 in the combination of X-axis number arrays is selected, the other five numbers should be selected from five vertical lines in the combination of X-axis number arrays and thus number 10 in the same vertical line in the combination of X-axis number arrays has to be excluded.

Since number 1 is selected and number 10 is excluded in the combination of X-axis number arrays, number 1 should be selected and number 10 should be excluded in the combination of Y-axis number arrays.

Numbers 2, 3, 4, 5, and 6 have to be selected in the other vertical lines in the combination of X-axis number arrays, and all Numbers 1, 2, 3, 4, 5, and 6 have to be selected in the combination of Y-axis number arrays.

If number 1 is excluded, 2, 3, 4, 5, 6, and 10 remain and thus two types of numbers can be selected. That is, the probability is enhanced 1/7 to ½ by 3.5 times. As shown in Table 5, Rules (1, 2) are appropriately applied to the above case.

TABLE 5
Example 1: winning numbers are assumed to be 1, 2, 3, 4, 5, and 6 (three odd numbers,
three even numbers)

| | |
|---|---|
| Vertical lines of X to be marked: Lines 1, 2, | Numbers of X: 30 numbers 30C6 = 1/593,775 |
| 3, 4, 5, and 6 | Numbers of Y: 10 numbers 10C6 = 1/210 |
| Vertical lines of Y to be marked: Lines 1 and 2 | |
| X∩Y: reduction to 1, 2, 3, 4, 5, 6 | Numbers of X and Y: 7 numbers, |
| | reduction to 7C6 = 1/7 |

Odd and even: three odd numbers and four even numbers That is, since even numbers are
1.3 times (4/3) more than odd numbers, three or more odd numbers are predicted to be
included in six winning numbers.
Rule application: reduction of probability to 1/2 after (1) and (2)
Conclusion: Since the probability of only X 30C6 = 1/593,776 and the probability of only Y
10C6 = 1/210 is reduced to the probability of common numbers X∩Y 7C6 = 1/7 and the number of
winning number ranges is reduced to 1/2 after application of the rule, the winning probability is enhanced.

8-2) As shown in Table 6,

### EXAMPLE 2

It is assumed that the winning numbers 2, 10, 11, 19, 20, and 29 (three odd numbers and three even numbers)

By X∩Y, ten numbers in the combination of X-axis number arrays are reduced to eight common numbers and the number of cases is ₈C₆=28.

In the combination of Y-axis number arrays, absolute numbers 10 and 11 appear, the number of cases is ₆C₄=15, and four numbers should be selected from the remaining three lines. Accordingly, as shown in Table 7,

at least one line is (1, 2), (19, 20), or(28, 29) including two numbers. Accordingly, it can be seen that the number of cases is reduced to 15-3=12.

TABLE 7
Example 2: winning numbers are assumed to be 2, 10, 11, 19, 20, and 29 (three odd
numbers, three even numbers)

| | |
|---|---|
| Vertical lines of X to be marked: Lines 1 and 2 | Numbers of X: 10 numbers 10C6 = 1/210 |
| Vertical lines of Y to be marked: Lines 1, 2, | Numbers of Y: 25 numbers 25C6 = 1/177,100 |
| 3, 4, and 6 | |
| X∩Y: reduction to 1, 2, 11, 19, 20, 28, and 29 | Numbers of X and Y: 8 numbers, |
| | reduction to 8C6 = 1/28 |

Odd and even: four odd numbers and four even numbers That is, since even numbers are
equal to odd numbers, two, three, or four odd numbers are predicted to be included in
six winning numbers.
Rule application: After (1) and (2), absolute numbers 11 and 12 appear in Y and are
selected, two winning numbers of the remaining four winning numbers are necessarily
present in one vertical line of three vertical lines. In consideration of 6C4 = 15 (−3) =
1/12 and a ratio of odd and even numbers of 3:3, the probability can be enhanced to 1/10.
Conclusion: Since the probability of only X 10C6 = 1/210 and the probability of only Y
25C6 = 1/177,100 is reduced to the probability of common numbers of X∩Y 8C6 = 1/28, the
probability is further reduced from 1/15 to 1/12 due to appearance of absolute numbers
after application of the rule, the probability is reduced to 1/10 in consideration of an
odd-even ratio, and thus the winning probability is further enhanced.

Therefore, in the combination of X-axis number arrays (X) in Example 1, since the absolute numbers of the vertical lines can be visually distinguished, numbers 2, 3, 4, 5, and 6 have to be selected without taking the probability into consideration, and only the other one can be selected from the other vertical lines. In the combination of Y-axis number arrays (Y), there is no absolute number and ₇C₆ needs to be applied. However, by applying the automatic verification function, numbers can be easily selected from the combination of Y-axis number arrays, because the numbers selected from the combination of X-axis number arrays have to be selected from the combination of Y-axis number arrays.

Example 2 is similar to Example, but has a great difference.

Since the number range is narrowed by X∩Y and the absolute number appears in only the combination of Y-axis number arrays unlike the combination of X-axis number arrays in Example 1 and thus can be excluded from the numbers of the combination of X-axis number arrays, it can be seen that the total probability in the combination of X-axis number arrays and the combination of Y-axis number arrays is enhanced.

Accordingly, the combination of X-axis number arrays and the combination of Y-axis number arrays have a function of enhancing the probability of the predicted winning numbers by the cooperative correspondence and the automatic verification function.

Since the winning probability of the first grade which is 1/8,145,060 includes several hundred thousands cases of continuous numbers such as numbers 1, 2, 3, 4, 5, and 6, or numbers 1, 2, 3, 4, 5, and 7, or numbers 1, 2, 3, 8, 9, and 10 and one case thereof can occur for each round, extraction of common numbers by X∩Y and the above-mentioned rules have features capable of logically extracting or excluding continuous numbers.

Conclusion: According to the invention, since the winning probability 1/₃₀C₆= 1/593,775 for extracting six numbers from thirty numbers in the conventional method can be enhanced to ½ and a number having a very low probability can be extracted or excluded by the rules including the automatic verification function as described above, the winning probability can be further enhanced in comparison with a conventional method which is used by a user or a lottery service provider.

2. Method of Generating a Group of Number Ranges

Purpose: Instead of extracting individual numbers and generating a number range, a predicted number range is extracted and provided from a group in which a winning number range is defined for each round.

1) Since winning numbers include six different numbers and on vertical line in the 9×5 form includes only five numbers, the winning numbers are present in only two vertical lines to six vertical lines and positions of the marked vertical lines are included in the winning number range.

The combination of X-axis number arrays (9×5) and the combination of Y-axis number arrays (9×5) have the same space size, and thus have the same marked positions and the same number of marked spaces in the vertical lines.

Here, since the combination of Y-axis number arrays has number arrays different from the predicted winning number range generating method, the position of a marked vertical line in the combination of Y-axis number arrays is different from the position of a marked vertical line in the combination of X-axis number arrays.

2) Since the number of winning numbers is six, the number of cases of the vertical liens to be marked in the combination of X-axis number arrays is ₉C₂+₉C₃+₉C₄+₉C₅+₉C₆=456, the number of cases in the combination of Y-axis number arrays is also 456, and the number of cases of the vertical lines to be marked is the number of cases which can be combined by X∩Y, (X)456×(Y)456=207,936 is the number of number ranges which can be extracted by X∩Y.

3) In order to check, record, store winning ranges of the lotto winning numbers generated for each round, 207,936 vertical lines to be marked should be compared between the combination of X-axis number arrays and the combination of Y-axis number arrays. This comparison can be performed by a computer, but there are temporal and spatial restrictions in visually distinguishing the vertical lines.

Therefore, another system for solving the above-mentioned problems and clearly reducing 207,936 cases so as to be visually distinguished has been invented.

2-1 Generation of Number Range Group

1) Since the positions and the numbers of the vertical lines to be marked in the combination of X-axis number arrays and the combination of Y-axis number arrays are the same, the combination of X-axis number arrays will be mainly described for the purpose of convenience.

2) In order to understand the tendency of the winning numbers by numbers, the combination of the X-axis number arrays is divided into three sections A, B, and C as shown in Table 8.

When nine horizontal spaces of 9×5 (columnsXrows) in the combination of X-axis number arrays are divided into three sections XA(3×5), XB(3×5), and XC(3×5) and A, B, and C are combined into X(A×B×C) under the same conditions, the number of combinations is the same as the total number of combinations corresponding to the winning number range of 9×5 of the combination of X-axis number arrays. When the positions to be marked in three vertical lines of XA are assumed to be the same as shown in Table 9, each vertical line is an individual set including five numbers.

TABLE 9

| | Marked position | | | | | | | |
|---|---|---|---|---|---|---|---|---|
| | 0 | 1 | 2 | 3 | 1 + 2 | 1 + 3 | 2 + 3 | 1 + 2 + |
| | line | line | line | line | line | line | line | 3 line |
| Individual | a | b | c | d | e | f | g | h |
| set | | | | | | | | |

A(3×5) includes three vertical lines and combinations from zero vertical line in which no vertical line is marked to three vertical lines which are marked are eight individual sets. This is true of B and C.

In other words, 8=2³ and (A)8×(B) 8×(C)8=(A)2³×(B)2³×(C)2³ are established.

3) Since eight combinations of X(ABC) are possible from 2³ of XA, XB, and XC, four individual sets among eight individual sets in which the vertical lines are marked are combined into one set as shown in the following table and two double set symbols 2 and 3 are applied to X(ABC) to obtain Table 10.

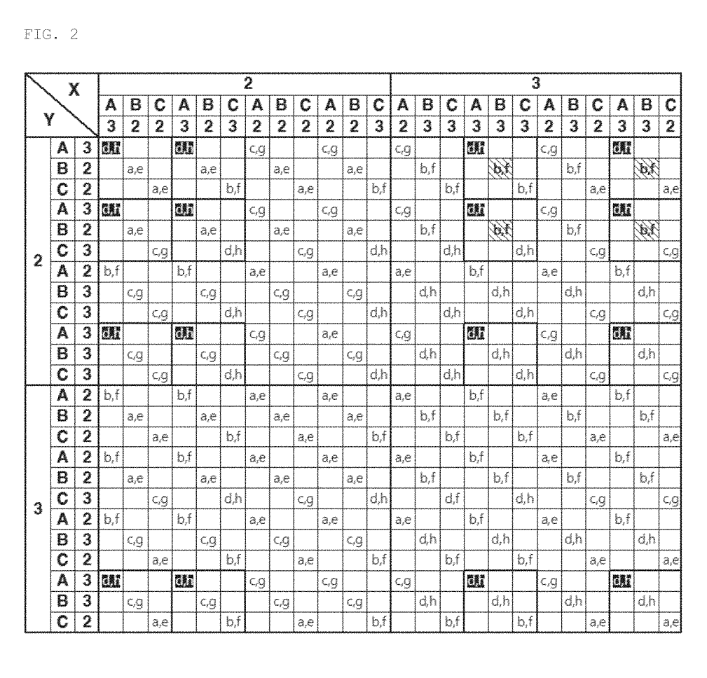

As illustrated in the upper part of the X axis in FIG. 2,

Eight number range arrangements of (1) 2, 2, 2, (2) 2, 2, 3, (3) 2, 3, 3, (4) 2, 3, 2, (5) 3, 3, 2, (6) 3, 2, 3, (7) 3, 2, 2, and (8) 3, 3, 3 are formed. When the double set (X(ABC) of the number range arrangement is set for an x axis (horizontal) and X(ABC) having an arrangement different from the x axis (horizontal) vertical is set for a y axis as illustrated in FIG. 2, x includes a double set 2(a, e, c, g) on the horizontal axis and a double set 3(b, f, d, h), and y includes a double set 2(a, e, b, f) and a double set 3(c, g, d, h) on the vertical axis.

Since (x) and (y) of X are different from each other in the positions of the vertical lines of elements (individual sets) of the double set, groups of number ranges of 64 sections with a combination of 23 are generated at intersection positions of X(x)∩X(y) as illustrated in FIG. 2 as the number range arrangement order in a state in which eight double sets of X(x) are arranged horizontally and eight double sets of X(y) are arranged vertically.

As a result, since eight individual sets are present on the horizontal axis of X and eight individual sets are present on the vertical axis,

[2³×8 (horizontal axis)=64 sections, 64×8 (vertical axis)=512] number ranges are obtained.

Since 512 individual sets are generated for Y similarly to X, the number of combinations of X and Y is 512×512=262,144 number ranges.

It can be seen that a number range including winning numbers for each round is present therein. Here, 262,144 number ranges are condensed into coordinates so as to be visually distinguished.

On the other hand, X(9×5) includes 456 number ranges and X(3×5) includes 512 number ranges. That is, since 512 number ranges of X(3×5)ABC which is one of three sections of X(9×5) are vertical lines to be marked including zero line, one line, seven lines, eight lines, and nine lines,

it can be seen that there are ₉C₀+₉C₁+₉C₇+₉C₈+₉C₉=56 invalid number ranges.

Therefore, in the invention, 456×456=207,936 number ranges of X(9×5) are included and 56 invalid vertical lines can be easily confirmed and excluded by A+B+C. As a result, the number of invalid number ranges is 262-144-207,936=54,208 which is about 20%. Table 11 shows an example of invalid number ranges.

3. Method of Extracting Number Ranges (Positions of Vertical Lines to be Marked)

Principle: A(x∩y), B(X∩y), and C(x∩y) of X are extracted.

A(x∩y), B(x∩y), and C(x∩y) of Y are also extracted.

1) An example of the 634-th lotto winning numbers is shown in Table 12.

In the 634-th lotto winning numbers, X(ABC)=(A)h, (B)b, (C)d and the marked position in the vertical lines of XA is h, that is, 1+2+3=h.

The set symbol including h in XAx is 3 and the set symbol including h in XAy is 3. Accordingly, XAx is 3 and XAy is 3.

When elements of set 3 of XAx and elements of set 3 of XAy are intersected (XAx∩XAy), it can be seen that coinciding elements are d and h as common numbers in FIG. 2.

2) In XB, b is marked in a vertical line. Accordingly, the set of XBx is 3, the set of XBy is 2, and the common numbers are b and f.

3) In XC, d is marked in the vertical line. Accordingly, the set of XBx is 3, the set of XBy is 3, and the common numbers are d and h.

Conclusively, the sets of X(ABC) are 3, 3, and 3 and the sets of Y(BAC) are 3, 2, and 3.

4) A(d, h), B(b, f), and C(d, h) are extracted at intersections of 3, 3, and 3 of the X axis and 3, 2, and 3 of the Y axis. Accordingly, it can be seen that the number of combinations thereof is eight in total (2×2×2=2³) and the winning numbers are present in the number ranges.

5) Number range predicting method using the group of number ranges

When only the elements of XA(d, h) are extracted instead of all ABC of X, it can be seen that XA(d, h) are present in only the individual sets of 16 sections among the individual sets of 64 sections in the group illustrated in FIG. 2 and the number ranges to be extracted are reduced. The reduced number ranges are illustrated in blue in FIG. 2.

When only the elements of XA(d, h) and XB(b, f) in ABC of X are extracted, it can be seen that the winning numbers are present in four sections as illustrated in yellow in FIG. 2 and thus the predicted winning number range can be easily extracted even by extracting only the elements of A(x∩y) and B(x∩y).

That is, the number ranges of ABC of X in 16 sections can be extracted using the group of number ranges by extracting only the elements of XA, and the number ranges of ABC of X in 16 sections can be reduced to the number ranges of ABC of X in four sections by simultaneously extracting the elements of XA and XB. At this time, the number of cases is as follows.

(1) When only the elements of XA are extracted, the number ranges of ABC of X in 16 sections can be extracted. Since one section includes eight number ranges, the number of number ranges for X is 8×16=128. Since the elements for Y are not extracted, the number of number ranges of ABC of Y is 128×512=65,556.

(2) When the elements of XA and XB are extracted, the number ranges in four sections can be extracted and the number of number ranges is 4×8×512=16,384.

(3) When all the elements of XA+XB+XC(d, h) are extracted, 1×8×512=4,096 number ranges are extracted.

6) Y(ABC)=(A)h, (B)f, (C)a: 1+2+3=6 is marked in the vertical lines for A of Y, 1+3=4 is marked in the vertical lines for B of Y, and 0 is marked in the vertical lines for C of Y.

The set of A(x) of Y is 3 and the set of (y) is 3—elements d and h are generated in YA(x∩y)

The set of B(x) of Y is 3 and the set of (y) is 3—elements b and f are generated in YB(x∩y)

The set of C(x) of Y is 2 and the set of (y) is 2—elements a and e are generated in YC(x∩y)

Accordingly, A(x), B(x), and C(x) of Y are 3, 3, and 2, and A(y), B(y), and C(y) of Y are A(d, h), B(b, f), and C(a, e) by Y by A(x∩y), B(x∩y), and C(x∩y).

The winning numbers are h, b, and d in X, and are h, f, and a in Y, and the number ranges are extracted in the form of one section of A(d, h), B(b, f), and C(a, e) of X and A(d, h), B(b, f), and C(a, e) of Y.

7) Total probability: The marking of the vertical lines for the winning numbers at 634-th lotto is performed as follows.

(1) The x sets of X are 3, 3, and 3, the y sets are 3, 2, and 3, and the elements of x∩y are A(d, h), B(b, f), and C(d, h) of X. (2) The x sets of Y are 3, 3, and 2, the y sets are 3, 2, and 2, and the elements of x∩y are A(d, h), B(b, f), and C(a, e) of Y. As shown in Table 13, (1) when A(d, h) of X and A(d, h) of Y are extracted, (x)16×(y)l6=256 number ranges are extracted. Since eight elements are present in one individual set, x(8×16)×y(8×16)=64×256=16,384 number ranges are extracted in total.

(2) When A(d, h) and B(b, f) of X and A(d, h) of Y are extracted, the number of number ranges of 4×16=64 sets is x(8×4)×y(8×16)=32×128=4,096.

(3) When A(d, h) and B(b, f) of X and A(d, h) and B(b, f) of Y are extracted, the number of number ranges extracted is 4×4=16.

The number of number ranges is x(8×4)×y(8×4)=32×32=1,024.

(4) When A(d, h), B(b, f), and C(d, h) of X and A(d, h) and B(b, f) of Y are extracted, the number of number ranges is 1×4=4.

The number of number ranges extracted is x(8×1)×y(8×4)=8×32=256.

(5) When A(d, h), B(b, f), and C(d, h) of X and A(d, h), B(b, f), and C(a, e) of Y are all extracted, the number of number ranges is 1×1=1. The number of number ranges extracted is x(8×1)×y(8×1)=8×8=64.

Since 54,208 invalid number ranges which are about 20% are included in 263,144 number ranges, the probability can be enhanced by about 20%.

TABLE 13

| | |
|---|---|
| X(ABC) = h + b + d, Ad(d, h), B(b, f), C(d, h) | Y(ABC) = h + f + a, d, Ad(d, h), B(b, f), C(a, e) |
| XA (16 sections), (8 × 16) = 128, 128 × 512 = 65,536 | Combinations of Y(ABC) are the same as in X |
| X(ABC) = 4 seconds, 4 × 8 × 512 = 1/16,384 | |
| X(ABC) = 2 seconds, 2 × 8 × 512 = 1/8,192 | |

When X(ABC) and Y(ABC) are extracted by phases, a probability is changed
(1) A(d, h) of X and A(d, h) of Y: x(8 × 16) × (8 × 16) = 64 × 256 = 1/16,384
(2) A(d, h) and B(b, f) of X and A(d, h) of Y: x(8 × 4) × y (8 × 16) = 32 × 128 = 1/4,096
(3) A(d, h) and B(b, f) of X and A(d, h) of Y: x(8 × 4) × y (8 × 4) = 32 × 32 = 1/1,024
(4) A(d, h), B(b, f), C(d, h) of X and A(d, h) and B(f, f) of Y: x(8 × 1) × y (8 × 4) = 8 × 32 = 1/256
(5 A(d, h), B(b, f), C(d, h) of X and A(d, h), B(f, f), C(e, f) of Y: 8 × 8 = 1/64
Conclusion: The probability is enhanced by about 20% by excluding invalid numbers from the probabilities.

4. Method of extracting number ranges by understanding tendency of winning numbers (only one set is described): There are A(x∩y), B(xrly), C(x∩y) of X and A(x∩y), B(x∩y), C(x∩y) of Y.

DB Storage Method

Since ABC of X has the same conditions, only XA will be described below.

The above table shows set symbols of elements of (x) and (y) in section A of the vertical lines to be marked according to the winning numbers for each round.

The set of the horizontal set (upper part) of Ax of A is 2 and the elements thereof are a, e, c, and g.

The set of the horizontal set (lower part) of Ax of A is 3 and the elements thereof are b, f, d, and h.

The set of the vertical set (left part) of Ay of A is 2 and the elements thereof are a, e, b, and f.

The set of the vertical set (right part) of Ay of A is 3 and the elements thereof are c, g, d, and h.

Since the vertical lines to be marked with the winning numbers for each round corresponding to XA are always present in Ax and Ay, the sets included in Ax and the sets included in Ay are recorded and stored for each round.

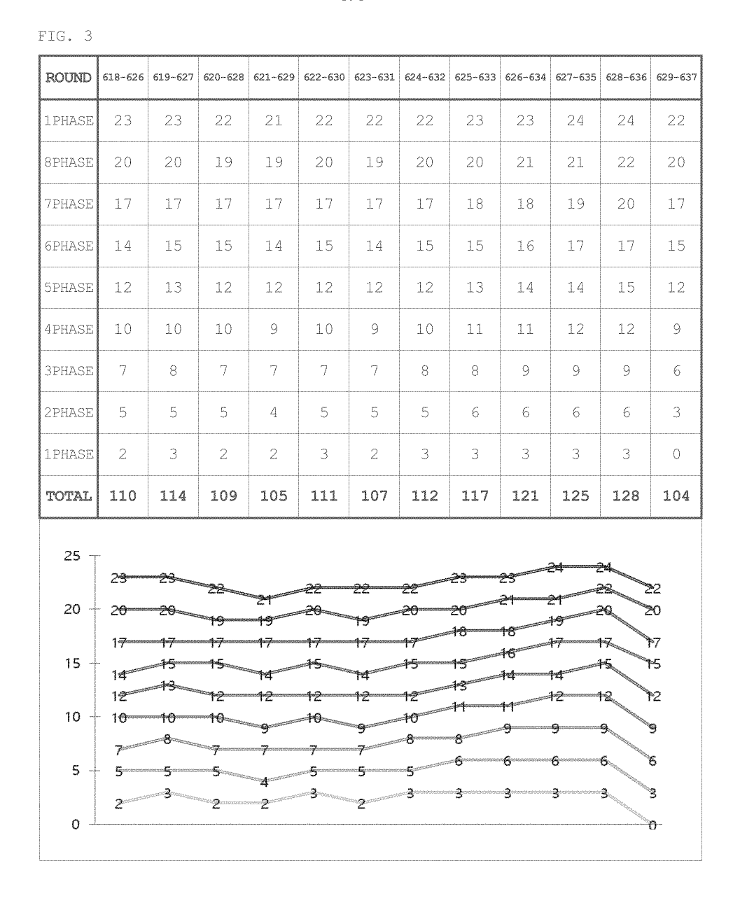

FIG. 3 is a graph illustrating the sets recorded in x of XA.

Data in which a current round to a round nine rounds before are represented in a first phase (current) to a ninth phase (nine rounds before) using set symbols and a tendency of winning numbers is continuously expressed in the form of a chart is illustrated in FIG. 3.

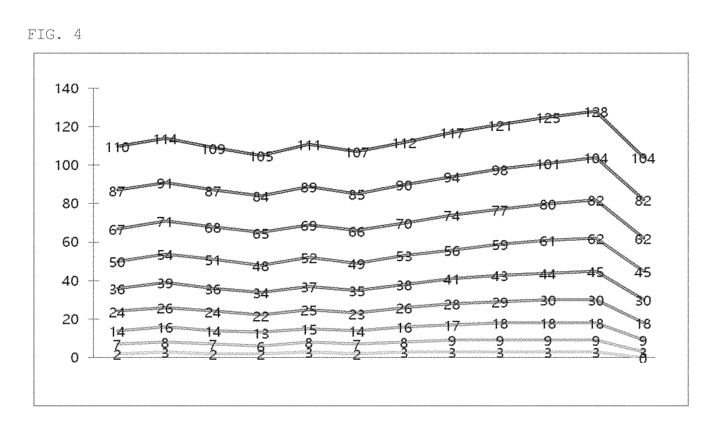

It can be seen that the tendency and a change in a high-low difference constitute a pattern having various shapes in each phase and that the tendency from the first phase to the ninth phase (FIG. 4) forms a wave shape as a whole.

2) From 617-th to 637-th

The first phase is a record of set symbols (hereinafter referred to as sets) corresponding to the vertical lines to be marked with the lotto winning numbers for each round (with respect to the 637-th lotto), the second phase is a subsequent record obtained by summing the sets of the 637-th+636-th rounds, the third phase is a subsequent record obtained by summing the sets of the 637-th+636-th+635 th rounds, the fourth phase is a subsequent record obtained by summing the sets of the 637-th+636-th+635 th+634-th rounds. This method capable of analyzing a tendency of sets from the first phase (the 637-th) to the ninth phase (nine phases before, the 629-th) using one piece of data is radically different from the conventional methods using often coming-up numbers and less coming-up numbers.

Features: (1) By classifying recently coming-up winning numbers into three phases from the current round to the round nine rounds before and recording and storing data obtained by continuously grasping the tendency, it is possible to finely predict in what direction the winning numbers move.

(2) It can be seen that the entire tendency of the lotto winning numbers moves in a wave form like a tendency of stock prices and that the tendency moves in a constant direction from the first phase to the ninth phase.

(3) It can be seen that a highest point and a lowest point are clearly distinguished from each other in view of the tendency of data into which the randomly moving tendencies of the first phase to the ninth phase are unified.

(4) The tendencies of the first phase to the ninth phase are classified by phases, sums (see FIG. 4), and averages and are stored in the DB and the tendency of the winning numbers for each round is analyzed.

(5) When the tendencies of the winning numbers in (x) and (y) of XA are grasped by phases from the first phase to the ninth phase, sums and averages and data into which XA(x+y) are unified, that is, the first phase (xy), the second phase (xy), the third phase (xy), . . . , the ninth phase (xy), are compared and analyzed by phases, averages, and sums, the tendencies move in five patterns of a pattern in which x and y meet each other, a pattern in which x and y do not meet each other, a pattern in which x and y are separated away from each other, a pattern in which x and y get close to each other, and a pattern in which x and y intersect each other.

(6) The principal feature in determining the tendencies by analysis using three types of six methods described above is that, when the tendencies are predicted, a particular start point (0 point of the first phase at the right end to 22 points of the ninth phase in FIG. 3) is defined instead of starting with a current point of each phase. That is, the start point is a reference point for each phase for extracting a current predicted number range to predict whether the tendency increases or decreases from the current point of each phase.

*Start point: Since nine rounds from the current round are included, the eighth phase is current and is a start point as for the ninth phase, . . . , and 0 is current and is a start point as for the first phase. Here, ″ refers to a state in which the predicted winning numbers of the current round are not known.

Basically, four sets of data of the set symbols having changed elements are provided. Here, only one set has been described above for the purpose of convenience, and it is possible to further narrow the predicted number range by collecting and analyzing data into which four sets are classified as described above.

Since the number ranges extracted from X(ABC) and Y(ABC) are analyzed for each section (A, B, C), it can be easily checked whether there is a difference in what section of the three sections from the winning numbers.

In order to embody the predicted winning number range generating method according to the invention having the above-mentioned configuration using a communication network, the predicted winning number range generating method can be provided by means of the winning number prediction application installed in a smartphone via the Internet.

The method of generating a predicted winning number range according to the invention includes: a downloading step of downloading a winning number prediction application that provides a predicted winning number range to a smartphone via the Internet, the predicted winning number range including a combination of X-axis number arrays (X) in which numbers 1 to 45 are sequentially or randomly described horizontally along horizontal arrays of nine numbers and vertical arrays of five numbers and a combination of Y-axis number arrays (Y) in which numbers 1 to 45 are sequentially or randomly described vertically along horizontal arrays of nine numbers and vertical arrays of five numbers;

a step of accessing the winning number prediction application, registering as a member, and logging on to the winning number prediction application;

a step of transmitting a request for predicted winning number range data in which the predicted winning number range is combined from the winning number prediction application to a management server;

a step of transmitting the requested predicted winning number range data from the management server to the winning number prediction application;

a step of sequentially or randomly inputting X-axis and Y-axis section number array sets X(A, B, C) and Y(A, B, C) and a group of individual number array sets (x, y) to the predicted winning number range data, the X-axis and Y-axis section number array sets X(A, B, C) and Y(A, B, C) including section number array sets by dividing the combination of X-axis number arrays (X) and the combination of Y-axis number arrays (Y) for predicted winning numbers three sections (A, B, C) based on the transmitted predicted winning number range data such that three horizontal number array sections (123), (245), and (789) and five vertical number arrays (12345) are formed and the group of individual number array sets (x, y) including eight types of groups (abcd) and (efgh) in which the X-axis section number array set and the Y-axis section array set include three horizontal (x) number arrays (123) and five vertical (y) number arrays (12345);

a step of extracting a common number (x∩y) of groups of x and y double set arrays (2, 3) which is formed such that four types (2: aecg) and (3: bfdh) of groups are defined to form a predicted number set in the group of the individual number array sets (x, y), extracting the predicted winning number range of individual sets (A+B+C), displaying the predicted winning number range in an image type on a display, and allowing a user to select predicted winning numbers from the displayed predicted winning number range and to request the management server to analyze the predicted winning numbers; and

a step of analyzing the predicted winning numbers input by the user and transmitting final predicted winning numbers to the winning number prediction application.

That is, a user installs a winning number prediction application for generating a predicted winning number range in a smartphone. A user having registered as a member in the winning number prediction application accesses the winning number prediction application and logs on to the winning number prediction application. At this time, a user not having registered as a member can first register as a member and then log on to the winning number prediction application.

A user transmits to the management server a request for the predicted winning number range data including a combination of X-axis number arrays (X) in which numbers 1 to 45 are sequentially or randomly described horizontally along horizontal arrays of nine numbers and vertical arrays of five numbers and a combination of Y-axis number arrays (Y) in which numbers 1 to 45 are sequentially or randomly described vertically along horizontal arrays of nine numbers and vertical arrays of five numbers. Then, the management server transmits the requested predicted winning number range data to the user in response to the request.

The user divides X-axis and Y-axis section number array sets X(A, B, C) and Y(A, B, C) into three sections (A, B, C) such that three horizontal number array sections (123), (245), and (789) and five vertical number arrays (12345) are formed using the combination of X-axis number arrays and the combination of Y-axis number arrays for generating the predicted winning numbers based on the predicted winning number range data and sequentially or randomly inputs data using the section number array sets.

Then, when common numbers (x∩y) of the groups of x and y double set arrays (2, 3) which are formed such that four types (2: aecg) and (3: bfdh) of groups are defined to form a predicted number set in the group of the individual number array sets (x, y) including eight types of groups (abcd) and (efgh) in which three horizontal (x) number arrays (123) and five vertical (y) number arrays (12345) are formed are extracted, the predicted winning number range of individual sets (A+B+C) is extracted, and the predicted winning number range in an image type is displayed on a display, the user selects predicted winning numbers from the displayed predicted winning number range and requests the management server to analyze the predicted winning numbers. Then, the management server analyzes the predicted winning numbers input by the user and gives the final predicted winning numbers to the user. At this time, The user can input the predicted winning numbers to the predicted winning number range including the combination of X-axis number arrays and the combination of Y-axis number arrays, but may transmit a predicted winning number range which has been automatically issued if necessary.

The combination of X-axis number arrays and the combination of Y-axis number arrays may be divided into 3×5 arrays to form the groups of x and y double set arrays (2, 3).

When the common numbers (x∩y) of the groups of x and y double set arrays (2, 3) are extracted and the predicted winning numbers of the individual sets (A+B+C) are extracted, the extracted predicted winning numbers are displayed in an image type on the display.

That is, the user installs the winning number prediction application for generating a predicted winning number range in a smartphone via the Internet.

The user accesses the winning number prediction application and logs on to the winning number prediction application. At this time, a user not having registered as a member can first register as a member and then log on to the winning number prediction application. The user transmits a request for the predicted winning number range data including the combination of X-axis number arrays and the combination of Y-axis number arrays (Y) for generating the predicted winning number range.

The user divides the X-axis and Y-axis section number array sets X (A, B, C) and Y (A, B, C) into three sections (A, B, C) such that three horizontal number array sections (123), (245), and (789) and five vertical number arrays (12345) are formed using the combination of X-axis number arrays and the combination of Y-axis number arrays and sequentially or randomly inputs the predicted winning numbers using the section number array sets.

Then, when common numbers (xi⁻1y) of the groups of x and y double set arrays (2, 3) which are formed such that four types (2: aecg) and (3: bfdh) of groups are defined to form a predicted number set in the group of the individual number array sets (x, y) including eight types of groups (abcd) and (efgh) in which three horizontal (x) number arrays (123) and five vertical (y) number arrays (12345) are formed are extracted, the predicted winning number range of individual sets (A+B+C) is extracted, and the predicted winning number range in an image type is displayed on a display, the user selects predicted winning numbers from the displayed predicted winning number range and requests the management server to analyze the predicted winning numbers. Then, the management server analyzes the predicted winning numbers input by the user and gives the final predicted winning numbers to the user.

At this time, the user can input the predicted winning numbers to the predicted winning number range including the combination of X-axis number arrays and the combination of Y-axis number arrays, but may transmit a predicted winning number range which has been automatically issued if necessary.

The combination of X-axis number arrays (X) has numbers 1 to 45 sequentially or randomly described horizontally along horizontal arrays of nine numbers and vertical arrays of five numbers, the combination of Y-axis number arrays (Y) has numbers 1 to 45 sequentially or randomly described vertically along horizontal arrays of nine numbers and vertical arrays of five numbers, horizontal and vertical number array combinations corresponding to six predicted winning numbers are extracted from the combination of X-axis number arrays (X) and the combination of Y-axis number arrays (Y), predicted winning numbers of a common set are extracted from each of the extracted horizontal and vertical number array combinations, an absolute number is extracted from one or more predicted winning numbers described in the horizontal arrays and predicted winning numbers described respectively in the vertical arrays, ratios of predicted odd winning numbers and predicted even winning numbers in predicted winning numbers including the absolute number are compared, and a mutual rule is applied to the X vertical lines and Y vertical lines to extract the final predicted winning numbers.

In order to extract the predicted winning number range as a graph,

0 is marked in a first phase, because current winning numbers are not known,

a sum of 0 of a current group of double set arrays and the group of double set arrays of the first phase corresponding to the winning numbers one round before is marked in a second phase,

a sum of 0 of the current group of double set arrays, the group of double set arrays of the first phase corresponding to the winning numbers one round before, and the group of double set arrays of the first phase corresponding to the winning numbers two rounds before,

a sum of 0 of the current group of double set arrays, the group of double set arrays of the first phase corresponding to the winning numbers one round before, and the winning numbers of two rounds and three rounds before is marked in a fourth phase,

a sum of 0 of the current group of double set arrays, the group of double set arrays of the first phase corresponding to the winning numbers one round before, and the winning numbers of two rounds, three rounds, and four rounds before is marked in a fifth phase,

a sum of 0 of the current group of double set arrays, the group of double set arrays of the first phase corresponding to the winning numbers one round before, and the winning numbers of two rounds, three rounds, four rounds, and five rounds before is marked in a six phase,

a sum of 0 of the current group of double set arrays, the group of double set arrays of the first phase corresponding to the winning numbers one round before, and the winning numbers two rounds, three rounds, four rounds, five rounds, and six rounds before is marked in a seventh phase,

a sum of 0 of the current group of double set arrays, the group of double set arrays of the first phase corresponding to the winning numbers one round before, and the winning numbers of two rounds, three rounds, four rounds, five rounds, six rounds, and seven rounds before is marked in an eighth phase,

a sum of 0 of the current group of double set arrays, the group of double set arrays of the first phase corresponding to the winning numbers one round before, and the winning numbers of two rounds, three rounds, four rounds, five rounds, six rounds, seven rounds, and eight rounds before is marked in a ninth phase, and

a graph obtained by connecting points of the groups of double set arrays prepared from the first phase to the ninth phase to points of the groups of double set arrays corresponding to the phases from a next round is displayed such that a tendency of predicted winning numbers is visually represented.

Accordingly, the number of cases of the vertical lines to be marked in the combination of X-axis number arrays (X) which is formed in the predicted winning number range data according to the invention is 512 as shown in Table 1, the number of cases at 6/45 lotto is 9C2+9C3+9C4+9C5+9C6=456, and the number of cases in the combination of Y-axis number arrays (Y) is 456. The number of case of the vertical lines is the number of cases which can be combined by X∩Y, and (456 combinations of X-axis number arrays)×(456 combinations of Y-axis number arrays)=207,936 are number ranges which can be extracted by X∩Y. Accordingly, it is possible to generate the predicted winning number range.

The invention including the above-mentioned steps can achieve the following advantages.

1) Six winning numbers can be finely analyzed by classifying X(ABC) and Y(ABC) into three sections (ABC) and nine phases (from the current phase to a phase nine rounds before).

2) A change of the tendency of the winning numbers can be easily determined by visually providing the nine phases (from the current phase to a phase nine rounds before).

3) A variety of data capable of comparing the tendencies of the winning numbers can be generated by changing set symbols or element arrangement in the analysis of three sections and nine phases.

4) Since set symbols (of elements and number ranges) of the predicted winning number range can be virtually input at a start point, the tendency of the current winning numbers can be predicted.

5) Data capable of comparing the tendencies of the winning numbers using three methods in one section can be generated. For example, (1) individual analysis of nine phases, (2) unified analysis of from the first phase to the ninth phase, and (3) average analysis of from the first phase to the ninth phase can be carried out.

In addition, the invention is characterized in that:

1. A group of number ranges includes 512 types of number ranges including six winning numbers which come up for each round, the combination of X-axis number arrays and the combination of Y-axis number arrays are divided into 64 sections, and the number ranges in which eight types of number ranges are independently condensed in sets of 2³(ABC) for each section can be visually recognized.

2. The tendency of the number ranges including the winning numbers for each round in the group of number ranges is analyzed by three sections and nine phases and the predicted winning number range can be extracted and provided.

3. The group of number ranges is formed to define only 512 types of number ranges, but serves as a signpost which is used to predict the predicted winning number range in the priority order of extracting the predicted winning number ranges from each of three sections of X(ABC) or Y(ABC) and to present a direction.

4. Unlike the conventional method of extracting new number ranges for each round by analyzing and extracting the predicted winning number range in the group of number ranges, it is possible to prevent discarding and repeated combinations, and since a changeable tendency of the winning number ranges can be predicted in only the group of number ranges, it is possible to perform stable combination.

5. Invalid number ranges can be visually distinguished in the 512 types of number ranges which are generated including the general combinations (456 types), and invalid numbers can be applied to a structure with whatever number arrangement such as 6/49 lotto (7×7) of USA, China, Germany, and Canada and 6/43 lotto (7×7) of Japan in addition to 6/45 lotto of Korea to extract number ranges.

6. Set symbols are used to analyze a tendency of winning number ranges as means for extracting number ranges, visual distinguishment is possible by continuously connecting nine phases from a current phase to a phase nine rounds before, a start point is used to predict a tendency of predicted number ranges based on a high-low difference, a highest point, and a lowest point, tendencies of various patterns of winning numbers can be multidirectionally by changing double set symbols or arrangement of set elements, and the winning numbers and incorrect positions can be easily checked for each section.

7. A predicted number range is extracted in the form of image data by X∩Y and a rule of cooperative correspondence between the combination of X-axis number arrays and the combination of Y-axis number arrays of the common numbers thereof is applied, thereby even a number having a very low winning probability can be selected or excluded.

While the technical concept of the invention has been described above with reference to the accompanying drawings, the above description is for describing preferable examples of the invention and does not limit the invention. It will be apparent to those skilled in the art that the invention can be modified in various forms without departing from the technical scope of the invention.

### INDUSTRIAL APPLICABILITY

The invention can provide predicted winning numbers to a user with a higher probability by allowing the management server to analyze conditions directly input by a user in response to a predicted winning number range supplied from the management server through the winning number prediction application installed in a smartphone via the Internet.

1. A method of generating a predicted winning number range, comprising:
a downloading step of downloading a winning number prediction application that provides a predicted winning number range to a smartphone via the Internet, the predicted winning number range including a combination of X-axis number arrays (X) in which numbers 1 to 45 are sequentially or randomly described horizontally along horizontal arrays of nine numbers and vertical arrays of five numbers and a combination of Y-axis number arrays (Y) in which numbers 1 to 45 are sequentially or randomly described vertically along horizontal arrays of nine numbers and vertical arrays of five numbers;
a step of accessing the winning number prediction application, registering as a member, and logging on to the winning number prediction application;
a step of transmitting a request for predicted winning number range data in which the predicted winning number range is combined from the winning number prediction application to a management server;
a step of transmitting the requested predicted winning number range data from the management server to the winning number prediction application;
a step of sequentially or randomly inputting X-axis and Y-axis section number array sets X(A, B, C) and Y(A, B, C) and a group of individual number array sets (x, y) to the predicted winning number range data, the X-axis and Y-axis section number array sets X(A, B, C) and Y(A, B, C) including section number array sets by dividing the combination of X-axis number arrays (X) and the combination of Y-axis number arrays (Y) for predicted winning numbers three sections (A, B, C) based on the transmitted predicted winning number range data such that three horizontal number array sections (123), (245), and (789) and five vertical number arrays (12345) are formed and the group of individual number array sets (x, y) including eight types of groups (abcd) and (efgh) in which the X-axis section number array set includes three horizontal (x) number arrays (123) and five vertical (y) number arrays (12345);
a step of extracting a common number (x∩y) of groups of x and y double set arrays (2, 3) which is formed such that four types (2: aecg) and (3: bfdh) of groups are defined to form a predicted number set in the group of the individual number array sets (x, y), extracting the predicted winning number range of individual sets (A+B+C), displaying the predicted winning number range in an image type on a display, and allowing a user to select predicted winning numbers from the displayed predicted winning number range and to request the management server to analyze the predicted winning numbers; and
a step of analyzing the predicted winning numbers input by the user and transmitting final predicted winning numbers to the winning number prediction application.

2. The method of generating a predicted winning number range according to claim 1, wherein the number of cases of vertical lines to be marked in the combination of X-axis number arrays (X) is 512, the number of cases at 6/45 lotto is 9C2+9C3+9C4+9C5+9C6=456, the number of cases in the combination of Y-axis number arrays (Y) is 456, X∩Y of the vertical lines is the number of combinations, and the number of number ranges which are extracted by X∩Y is (456 combinations of X-axis number arrays)×(456 combinations of Y-axis number arrays)=207,936.

3. The method of generating a predicted winning number range according to claim 1, wherein the combination of X-axis number arrays (X) has numbers 1 to 45 sequentially or randomly described horizontally along horizontal arrays of nine numbers and vertical arrays of five numbers, the combination of Y-axis number arrays (Y) has numbers 1 to 45 sequentially or randomly described vertically along horizontal arrays of nine numbers and vertical arrays of five numbers, horizontal and vertical number array combinations corresponding to six predicted winning numbers are extracted from the combination of X-axis number arrays (X) and the combination of Y-axis number arrays (Y), predicted winning numbers of a common set are extracted from each of the extracted horizontal and vertical number array combinations, an absolute number is extracted from one or more predicted winning numbers described in the horizontal arrays and predicted winning numbers described respectively in the vertical arrays, ratios of predicted odd winning numbers and predicted even winning numbers in predicted winning numbers including the absolute number are compared, and a mutual rule is applied to the X vertical lines and Y vertical lines to extract the final predicted winning numbers.

4. The method of generating a predicted winning number range according to claim 1, wherein 0 is marked in a first phase, a sum of 0 of a current group of double set arrays and the group of double set arrays of the first phase corresponding to the winning numbers one round before is marked in a second phase, a sum of 0 of the current group of double set arrays, the group of double set arrays of the first phase corresponding to the winning numbers one round before, and the group of double set arrays of the first phase corresponding to the winning numbers two rounds before, a sum of 0 of the current group of double set arrays, the group of double set arrays of the first phase corresponding to the winning numbers one round before, and the winning numbers of two rounds and three rounds before is marked in a fourth phase, a sum of 0 of the current group of double set arrays, the group of double set arrays of the first phase corresponding to the winning numbers one round before, and the winning numbers of two rounds, three rounds, and four rounds before is marked in a fifth phase, a sum of 0 of the current group of double set arrays, the group of double set arrays of the first phase corresponding to the winning numbers one round before, and the winning numbers of two rounds, three rounds, four rounds, and five rounds before is marked in a six phase, a sum of 0 of the current group of double set arrays, the group of double set arrays of the first phase corresponding to the winning numbers one round before, and the winning numbers two rounds, three rounds, four rounds, five rounds, and six rounds before is marked in a seventh phase, a sum of 0 of the current group of double set arrays, the group of double set arrays of the first phase corresponding to the winning numbers one round before, and the winning numbers of two rounds, three rounds, four rounds, five rounds, six rounds, and seven rounds before is marked in an eighth phase, a sum of 0 of the current group of double set arrays, the group of double set arrays of the first phase corresponding to the winning numbers one round before, and the winning numbers of two rounds, three rounds, four rounds, five rounds, six rounds, seven rounds, and eight rounds before is marked in a ninth phase, and a graph obtained by connecting points of the groups of double set arrays prepared from the first phase to the ninth phase to points of the groups of double set arrays corresponding to the phases from a next round is displayed such that a tendency of predicted winning numbers is visually represented.
